(19) United States
(12) Patent Application Publication
(10) Pub. No.: US 2012/0311658 A1
(43) Pub. Date: Dec. 6, 2012

(54) Access Control System and Method

(76) Inventor: Linda T. Dozier, Great Falls, VA (US)

(21) Appl. No.: 13/369,739

(22) Filed: Feb. 9, 2012

Related U.S. Application Data
(60) Provisional application No. 61/441,262, filed on Feb. 9, 2011.

(51) Int. Cl. G06F 21/00

(52) U.S. Cl. 726/1

(57) ABSTRACT

A system and method for managing access policies where the result of an intersection performed on policy sets associated with each of two nodes based on the nodes' attributes determines whether the two nodes may interact.

### CROSS-REFERENCE TO RELATED APPLICATIONS

The present application claims the benefit of U.S. patent application No. 61/441,262, entitled “Access Control System and Method” and filed on Feb. 9, 2011, in the name Linda T. Dozier, the disclosure of which is hereby incorporated by reference in its entirety as if set forth verbatim herein and relied upon for all purposes.

### FIELD OF THE INVENTION

The present invention relates generally to the implementation of access control policies and, more specifically, to implementation of such policies in online systems.

### BACKGROUND OF THE INVENTION

In current computing systems, access to resources is typically implemented by assigning users to one or more groups and giving specific permissions to those groups. Resources can generally be any item in the computing world, such as communications, files, databases, records within databases, programs, and user-specific data. For example, a file's permissions may be configured so that all users can see the file's content, but only members of a specific group may modify it and only members of another specific group may execute it. Some user groups may be role-based. For example, a “debugging group” may be able to update a virus definition for a system, while an “administrator group” typically has a wide set of permissions to modify the system, reset users' passwords, and so on.

Groups may also be used to represent organizational structure, such as, for example, Executive, Human Relations, and Finance. Members of the Human Relations group would have access to personnel records, whereas members of the Finance group would have access to the organization's financial records. Members of the Executive group would have access to all information except that protected by privacy laws, for instance.

Network or Internet-enabled environments generally, and email and social networking systems more particularly, typically allow users to communicate or interact online about various topics and categories of information. These systems normally set static permissions and rights for each user that define how the user interacts with the system and other users. A user may, with approval, join one or more groups of users formed within the system, where the user is then defined as being a part of the group (s). Communication between members of groups, and between members of different groups, is controlled by sets of rules. For example, members of a “Group A” can communicate with members of a “Group B,” but cannot communicate with members of a “Group C.” Default permissions may be configured to allow communications not specifically disallowed, or to disallow communications not specifically allowed. Controlling access to communications is especially important in the K-12 environment, where there are legal restrictions on communications with children 13 years of age and under.

This method of managing communication access encounters a scalability problem as organizations grow, generally resulting in users being associated with multiple groups, multiple roles, multiple structures, and/or multiple resources. In an education context, a user's role may be a student, parent, teacher, moderator, etc. The organizational structure may include various levels, such as district, school, classroom, teacher, and student. For instance, a teacher may have many students, and a student may have a half dozen teachers, several classrooms, and one school. The subject matter that may be associated with a user may include language arts, biological sciences, physical sciences, mathematics, etc. Moreover, in organizations like social networks, groups may be spontaneously created by users.

In a scenario where the default permission is to prevent communication, a determination must be made whether one user is allowed to communicate with another. Assuming each user belongs to multiple groups, a pairwise comparison between each group associated to one user is compared to each group associated with another in order to determine whether the users can communicate. Additionally, the rules of each group must be checked to determine whether intergroup communication is permitted. The scenario where the default permission is to allow is equally problematic, as the pairwise comparison must determine whether the specific intergroup communication is not permitted. If users on average belong to N groups, the computing problem is O(N²), where O is the order of algorithmic complexity, as should be understood in the art. In this scenario, the system struggles when the number of groups becomes large, as is likely the case in educational or social networks.

### SUMMARY OF THE INVENTION

The present invention recognizes and addresses the foregoing considerations, and others, of prior art construction and methods.

One aspect of the present invention relates to implementation of access control policies in the context of organizational units, role-based usage scenarios, and/or group-based models involving “membership” lists that may be open or restricted. For instance, one embodiment of the present invention is directed to implementation of such policies in conventional social network groups, role-based groups, or administratively-controlled groups arranged hierarchically, such as in enterprise or corporate contexts. These include access control groups, role-based access control (“RBAC”) scenarios, and restricted domains.

Nodes may include persons (or users), groups, addresses or locations, devices, and/or processes. Actions and functions may include communication functions, such as transmit, post, receive, etc., or access functions or permissions, such as those related to a file, workspace, authorized actions, such as execute and edit, and roles, such as administrator or user, and/or consequences of actions. An example of a consequence of an action may be the result of an action by a user or other node, such as executing a program and/or retrieving or displaying data. Actions and events in the system may include any function or action that takes place between two nodes. For example, a user or device attempting to contact another user or device, initiate a program, or access a file may all be examples of an action. Another aspect of the present invention relates to how policies desired to be applied to nodes may be specified and associated with a particular node and pertaining to one or more functions or actions, but may be operatively decoupled from the node.

Exemplary uses of such an embodiment include managing corporate email permissions and implementing policies in online environments used by heterogeneous, policy-regulated, role-based communities such as schools, and are particularly well-suited for contexts where policy management is needed due to regulation or sensitivity of information, where multiple groups or collaboration among individuals and groups of individuals is highly desirable, and where communication or user traffic is fairly frequent. The capability of specifying such policies in a manner that is independent of, but that can be operatively coupled with, one or more access control groups has several inherent advantages, including substantial operational efficiencies as groups and group memberships multiply in complex collaborative and policy-managed scenarios, and where groups and/or membership affiliations change.

The accompanying drawings, which are incorporated in and constitute a part of this specification, illustrate one or more embodiments of the present invention.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIGS. 1, 3, and 5 are flowcharts illustrating exemplary processes for establishing and assigning policies to nodes in a system in accordance with various embodiments of the present invention;

FIGS. 2, 4, and 6 are flowcharts illustrating exemplary processes for enforcing compliance with policies assigned to nodes in a system in accordance with various embodiments of the present invention; and

FIG. 7 is a schematic representation of a system for assigning and enforcing compliance with policies assigned to nodes that are distributed across multiple subsystems in accordance with an embodiment of the present application.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

A specific embodiment of the present invention pertains to online education systems. It should be understood, however, that the present invention is applicable to any networked system, such as those utilized by business or government entities or even across multiple entities of various types. For that reason, the following description includes an explanation of the embodiments of the present invention without regard to any specific implementation of the embodiments. However, to assist with the explanation, examples are provided in the context of an online education system. The description next provides an explanation of an embodiment of the present invention that may be used across multiple, different entities and systems, regardless of whether they are related to educational, commercial, or governmental units. It should be understood that the systems described herein are connected via a local or wide area network, such as the Internet, and may comprise one or more servers, computers, and/or mobile devices. Each of the devices includes memory and a processing device operatively connected to the memory. The devices' memories include instructions or computer code that, when executed by the respective processing device, perform one or more of the steps of the processes described below.

One aspect of the present invention pertains to the ability to determine if an action between two nodes in a network is allowed. For instance, the system determines whether one node may communicate with, act upon, access, or take some other action with respect to another node based on whether the nodes share a common access policy, independent of the specific content of the policy itself. That is, the system determines whether one node may take an action with respect to another node based on a comparison of the policies assigned to the nodes, irrespective of the content or meaning of the actual policies. One aspect of the present invention, for example, pertains to whether two or more users associated with respective nodes may communicate (or whether consequences attendant to such a communication are permissible). As noted above, a node may be any part of a system, such as a person/user, group, address or location, device, process, file, program, module, or application, or anything else that may be characterized as part of the system.

Each node is defined by one or more attributes, which are characteristics of the nodes associated with the system. The attributes may be any characteristic of a node, such as its location in the system, either physically or virtually, its location in the system's hierarchy (if the system has one), its name, its role, its functions, its events, etc. In the context of an online education system, and where the node is associated with a user of the system, the attributes may include the user's name, id, role (such as principal, teacher, student, parent, librarian, etc.), classes and/or grade (if the user is a student), identification of children (if the user is a parent of another user in the system), etc. It should be appreciated that each attribute may have one or more values. For instance, if the user associated with a particular node is a student in fourth grade, he will be associated with a “grade” attribute having the value of “5.” It should be understood that a node may have multiple values for certain attributes. For example, in the case where a node is associated with a student, the values for the node associated with the “classes” attribute may include a value identifying each of the student's classes.

An action in the system or network may be any event or other function that can occur with respect to the two nodes. For instance, an action may be a communication or transmission between the two nodes, a request by one node to access the other node or data related to the other node, or a request by one node to execute or initiate the other node.

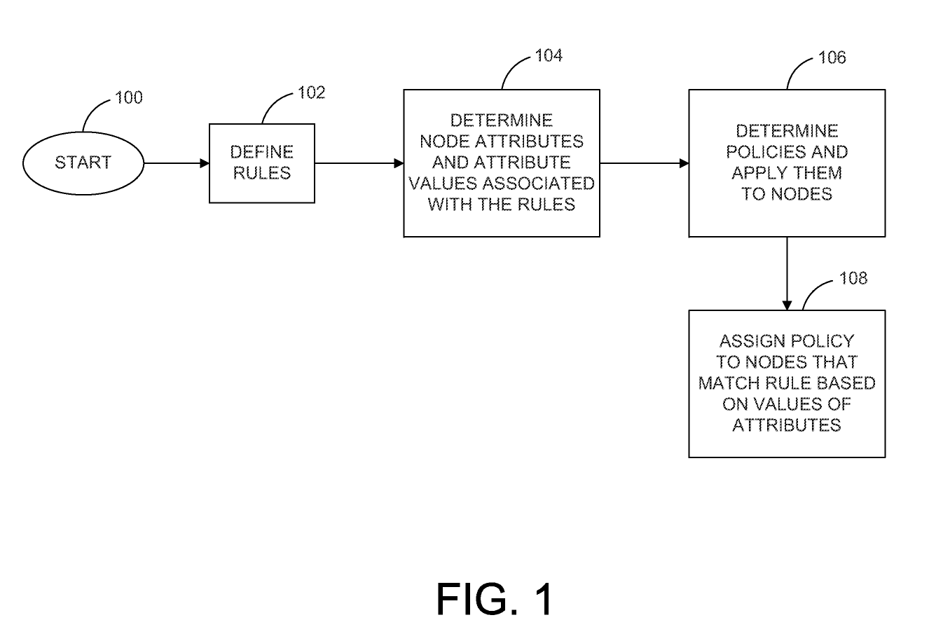

FIG. 1 illustrates an exemplary process for establishing and assigning policies to nodes in a system in accordance with an embodiment of the present invention. Referring to FIG. 1, the process begins at step 100, which may include any necessary initialization depending on the particular system. For instance, step 100 may include gathering or providing access to a repository that maintains the system's data. In the context of an education system, for example, step 100 may include providing access or arranging data contained in a corresponding student information system (or “SIS”). Step 100 may also include the initial set-up of the nodes in the system and organizing the data, attributes, and values associated with each node.

In an embodiment directed to an online education, for example, step 100 may include organizing the data contained in the SIS to be usable by the system in order to apply the rules and policies defined by the system, as explained below. It should be understood that the data may be arranged in any way understood by those of ordinary skill in the art without departing from the scope of the present invention. For example, nodes, their attributes, and the values of their attributes may be stored in objects associated with the nodes, in tables, matrixes, vectors, or in any combination thereof.

In one embodiment, the data associated with the system is maintained in tables. For example, a table may contain an identification of all the nodes in the system, as exemplified in Table 1 below for nodes 1-10 in an example system:

TABLE 1
Node id

1
2
3
4
5
6
7
8
9
10

Other tables in the system may be configured to store the attributes and attribute values for each node in the system. For instance, any attribute of the nodes in the system may be defined by a table and the values for nodes that are associated with the attribute stored in the table. Other tables may explain or better define an attribute or the values for an attribute. For instance, table 2 corresponds to a “type” attribute and associates each node with a value for the type attribute, while Table 3 provides a description of the type attribute.

TABLE 3

| | Type |
|---|---|
| Type | Description |
| 1 | User |
| 2 | Device |

TABLE 2

| Node id | Type id |
|---|---|
| 1 | 1 |
| 2 | 1 |
| 3 | 1 |
| 4 | 1 |
| 5 | 2 |
| 6 | 2 |
| 7 | 1 |
| 8 | 1 |
| 9 | 1 |
| 10 | 1 |

In this example, nodes 1, 2, 3, 4, 7, 8, 9, and 10 are users, whereas nodes 5 and 6 are devices. Tables may be designed to associate an attribute with nodes where more than one value for the attribute may be assigned to each node. Continuing with the example from above, Table 4 identifies the values for a “roles” attribute of the system, while Table 5 stores the values of the “roles” attribute with regard to each node.

TABLE 4

| Role | Role |
|---|---|
| id | Description |
| 1 | Superintendent |
| 2 | Principal |
| 3 | Teacher |
| 4 | Student |
| 5 | Parent |
| 6 | Librarian |

TABLE 5

| Node id | Role id |
|---|---|
| 1 | 1 |
| 1 | 5 |
| 2 | 2 |
| 2 | 3 |
| 3 | 4 |
| 4 | 5 |
| 7 | 4 |
| 8 | 4 |
| 9 | 4 |
| 10 | 4 |

As illustrated by Tables 4 and 5, node 1 is associated with the “role” attribute, for which the node has multiple values. In this example, node 1 is associated with both the roles of superintendent and parent. Likewise, node 2 is associated with both of the roles of principal and teacher. Node 4 is associated with the value of “parent” for the role attribute, while nodes 4, 7, 8, 9, and 10 are associated with the “student” role. Nodes 5 and 6 are not associated with the role attribute in this scenario. Also, none of the nodes are associated with the value of 6 for the role attribute (i.e., the role of “librarian”).

It should therefore be understood that tables may be added to the system for each attribute associated with any of the nodes, along with any additional tables necessary to define the attribute. For instance, Tables 6, 7, and 8 illustrate additional attributes that may be assigned to the nodes in this example system.

TABLE 6

| | Full |
|---|---|
| Node id | Name |
| 1 | John Smith |
| 2 | Jane Doe |
| 3 | James Smith |
| 4 | Mary Smith |
| 7 | George Washington |
| 8 | John Adams |
| 9 | Thomas Jefferson |
| 10 | James Madison |

TABLE 7

| Node id | Grade |
|---|---|
| 3 | 5 |
| 7 | 6 |
| 8 | 7 |
| 9 | 5 |
| 10 | 4 |

TABLE 8

| Node id | Class |
|---|---|
| 2 | 1 |
| 3 | 1 |
| 7 | 3 |
| 8 | 4 |
| 8 | 7 |
| 9 | 2 |
| 9 | 6 |
| 10 | 1 |
| 10 | 5 |

Thus, Tables 6, 7, and 8 associate the “full name,” “grade,” and “class” attributes, respectively, with nodes in the network and identify the value (s) for each attribute associated with a particular node.

Other tables may be used to define attributes of the nodes where the attribute is a relationship or other connection between two nodes. For instance, Table 9 identifies the association of any parent in the system to that parent's student in the system:

TABLE 9

| Node id | Node id |
|---|---|
| of Parent | of Student |
| 1 | 3 |
| 4 | 3 |

Thus, in this example, John and Mary Smith are the parents of James Smith.

Process flow proceeds to step 102 where rules are established for the system. The rules, for instance, define which nodes may communicate or what actions one node may take with respect to another node. For instance, an open system may have only one rule that any node may take any action with respect to any other node. A completely closed system may have only one rule that no node may take any action with respect to another node. While the presently-described embodiment contemplates such systems, it should be understood that most systems will include multiple rules, which may vary in complexity.

It should be appreciated from the ensuing description that certain aspects of the present invention simplify the application of multiple, complex rules to determine whether one node is able to take a specific action with respect to another node.

Continuing with the example of an online education system, for instance, the system may define the following rules:
The superintendent and principal may communicate with anyone in the system (Rule 1).
The superintendent, principal, and any teacher may use any device (Rule 2).
Each teacher may communicate with any other teacher (Rule 3), the students in their classes (Rule 4), and the parents of the students in their classes (Rule 5).
Each student may communicate with his or her teachers (Rule 6), his or her classmates (Rule 7), and his or her parents (Rule 8).
Each student in grade 6 or above can communicate with any other student in grade 6 or above (Rule 9).
Each student in a grade less than 6 may only communicate with other students in the same grade (Rule 10).
Each parent can communicate with his or her child(ren) (Rule 11) and the teachers of his or her child(ren) (Rule 12).
The devices of the system may only be used by, and may also transmit data to, the superintendent, principal, and teachers (Rule 13).
All other actions are prohibited (Rule 14).

At step 104, the system determines which attributes of the nodes in the system and which values of those attributes are associated with each rule. Rules may range anywhere from being based on one value of one attribute to taking into account multiple values of multiple attributes. Rules may also be based upon another rule or upon the attributes and attribute values upon which the other rule is based. In this example, each of the rules is associated with certain attributes as follows:
Rule 1 is based on the role attribute and specifically the values of “superintendent” and “principal.”
Rule 2 is based on the role attribute and specifically the values of “superintendent,” “principal,” “teacher,” and “device.”
Rule 3 is based on the role attribute and specifically the value of “teacher.”
Rule 4 is based on the class attribute and specifically whether any values of the attribute for one node match that of the value of another node.
Rule 5 is based on the class, role, and relationship attributes, where the values of each attribute are applied with respect to one another as explained in more detail below.
Rule 6 is related to Rule 4.
Rule 7 is based on the class attributes and specifically whether any value(s) of the attributes associated with one node match any of those associated with other nodes.
Rule 8 is based on the relationship attribute and whether one exists for a node.
Rule 9 is based on (1) the role attribute and specifically the value of “student,” and on (2) the grade attribute and specifically whether the value is equal to or greater than 6.
Rule 10 is based on (1) the role attribute and specifically the value of “student,” on (2) the grade attribute and specifically whether the value is less than 6, and, if so, (3) the actual value.
Rule 11 is related to Rule 8.
Rule 12 is related to Rule 5.
Rule 13 is related to Rule 2.
In this scenario, Rule 13 is the default rule that all actions should be prohibited unless otherwise specifically allowed.

At step 106, policies are defined based on the rules and are then applied to the nodes in the system based on the nodes' attribute(s). Each policy may include one or more rules, the combination of which identify what action one node may be able to perform with respect to another node. In a preferred embodiment, a policy is associated with a unique numerical id in order to simplify the application and enforcement of the policy as explained in more detail below. Policies may be based on the rules set forth in the example above as follows:
Policy 1 is based on Rules 1, 2, 3, and 13.
Policy 2 is based on Rules 1, 4, 6, and 7.
Policy 3 is based on Rule 9.
Policy 4 is based on Rules 1, 5, 8, 11, and 12.
Policy 5 is based on Rule 10.

It should be understood that each policy may include a number of sub policies when the policies are actually applied to the nodes due to the rules' conditions. For example, Policy 5 will include a policy for each value of the “grade” attribute lower than 6 to be applied to the nodes with the matching value for the grade attribute. That is, Policy 5 may include a policy for all second graders, a policy for all third graders, and so on. Likewise, Policy 4 will include a sub policy for each student in a teacher's class to which a parent is associated. As a result, a unique policy will be assigned to the student, parent, and teacher in order to allow them to communicate, but another policy will be assigned to another student and that student's parent, as well as the teacher, in order to allow them to communicate. The system is therefore configured to prevent communications of one student to an unrelated parent and vice versa.

In one embodiment, the system assigns unique ids to the policies and stores the ids in the system's database, such as exemplified by Table 10 below:

TABLE 10

| Policy id | Policy |
|---|---|
| 1 | Policy 1 |
| 2 | Policy 2 |
| 3 | Policy 3 |
| 4 | Policy 4 |
| 5 | Policy 5 |

As step 108, the policies are then assigned to the nodes that match the conditions of the rules upon which the respective policy is based. Following the example from above, the policies may be applied as follows:
Policy 1 is applied to every node in the network because the superintendent and principal are allowed to act upon any other node in the system.
Policy 2 is applied to nodes 2, 3, and 10 because they are all associated with class “1.”
Policy 3 is applied to every student in grade 6 or above, which, in this example, are nodes 7 and 8.
A unique sub policy of Policy 4 is applied to every student associated with a parent and to the student's parents. In this example, there is only one familial relationship defined in the system, which is that between the student associated with node 3 and the parents associated with nodes 1 and 4. Accordingly, Policy 4 is applied to nodes 1, 3, and 4. The policy is also applied to any teachers associated with node 3, which is node 2 in this example.
A unique sub policy of Policy 5 is applied to students in grades less than sixth and that are in the same grade. In this example, only nodes 3 and 9 are associated with students in grades less than sixth and that are in the same grade. Thus, Policy 5 is applied to these nodes.

In the presently-described embodiment, another table is created in order to associate the policies to the relevant nodes, such as Table 11 set forth below. Table 11 may be sorted by policy to show all nodes associated with a particular policy. In this example, however, Table 11 is sorted by node in order to identify all policies associated with a node as follows:

TABLE 11

| Node id | Policy id |
|---|---|
| 1 | 1 |
| 1 | 4 |
| 2 | 1 |
| 2 | 2 |
| 2 | 4 |
| 3 | 1 |
| 3 | 2 |
| 3 | 4 |
| 3 | 5 |
| 4 | 1 |
| 4 | 4 |
| 5 | 1 |
| 6 | 1 |
| 7 | 1 |
| 7 | 3 |
| 8 | 1 |
| 8 | 3 |
| 9 | 1 |
| 9 | 5 |
| 10 | 1 |
| 10 | 2 |

Step 108 also includes organizing the policies for each node into a policy set. This allows for the comparison of the policies of one node with those of another node as explained below. The policy set may be represented as any variable such as a delimited array. That is, the policy ids may be stored in an array for each node where the policy ids are separated by a predefined character such as a comma or semicolon. It should be understood, however, that different storage structures, such as tables, vectors, objects, and lists, may be used to represent the policy set without departing from the scope of the present invention. In this example, the policy sets for each node may be represented as follows:

| Node id | Policy set |
|---|---|
| 1 | {1; 4} |
| 2 | {1; 2; 4} |
| 3 | {1; 2; 4; 5} |
| 4 | {1, 4} |
| 5 | {1} |
| 6 | {1} |
| 7 | {1; 3} |
| 8 | {1; 3} |
| 9 | {1; 5} |
| 10 | {1; 2} |

As illustrated above, each node in this example is associated with at least one policy due at least in part to the rule that the superintendent is able to communicate or otherwise take action with respect to any of the other nodes. It should be understood, however, that nodes do not have to be associated with any policies. In such a scenario, the policy set assigned to such a node is empty or null.

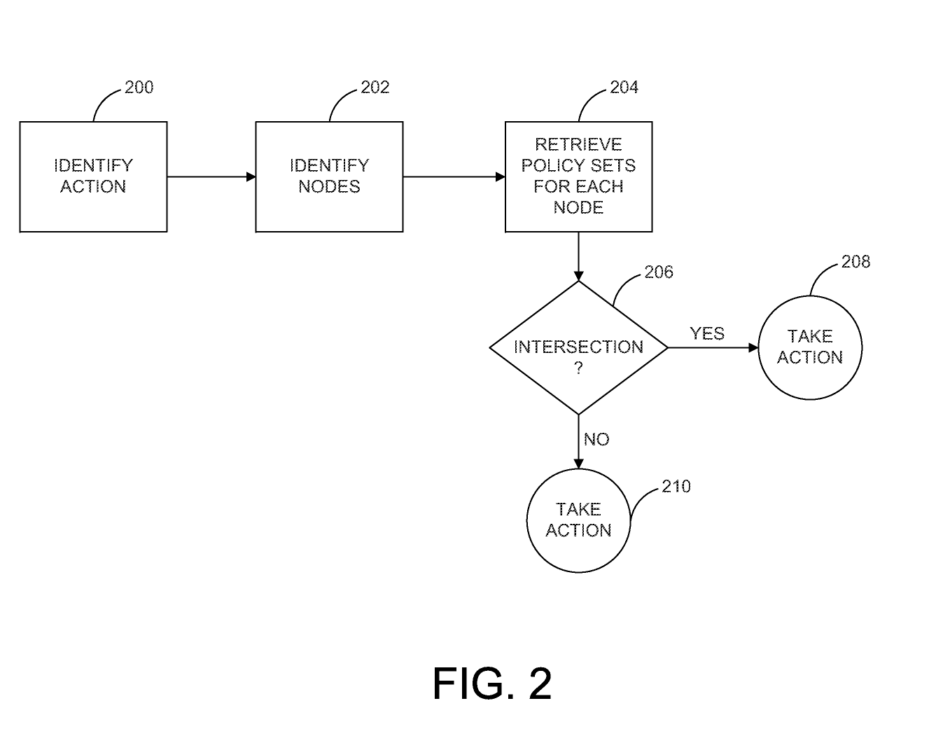

FIG. 2 illustrates an exemplary process for enforcing compliance with policies assigned to nodes in a system in accordance with an embodiment of the present invention. Referring to FIG. 2, the process begins at step 200 where the system identifies an action that is requested to take place. As set forth above, an action may be an attempt by one node to access, communicate with, use, or execute another node. For example, the user associated with node 3 seeks to send an email to the users associated with nodes 7, 9, and 10. In this example, there are actually three actions: the attempt to send the email from node 3 to node 7, from node 3 to node 9, and from node 3 to node 10.

Once the action is identified, the two nodes associated with the action are identified at step 202. Following the example above, the two nodes for each of the three actions are 3 and 7, 3 and 9, and 3 and 10.

At step 204, the set of policies for the two nodes are retrieved and compared. Using the above example of an email from the user associated with node 3, the system retrieves the policy set for node 3 ({1; 2; 4; 5}) and compares it to the policy set of the other node with respect to each action. Thus, the policy set associated with node 3 is compared to the policy set associated with node 7 ({1; 3}), the policy set associated with node 9 ({1; 5}), and the policy set associated with node 10 ({1; 2}).

The system determines if an intersection exists between the two policy sets that are compared with respect to an action. An intersection exists if there is any commonality between the two policy sets. Namely, if at least one policy is assigned to both nodes, then there is an intersection between the two sets and process flow proceeds to step 208. Examples of determining whether an intersection exists between two sets are provided below. In the example provided above, there is an intersection between the policies of nodes 3 and 7, nodes 3 and 9, and nodes 3 and 10.

If an intersection exists, the system performs the appropriate action at step 208, which is typically the action identified at step 200. For instance, because an intersection exists for each of the comparisons of the policy set associated with node 3 and with the policy sets associated with nodes 7, 9, and 10, the action identified at step 200 is a allowed. That is, the system permits the transmission of the email message identified at step 200 from node 3 to nodes 7, 9, and 10 at step 208.

It should be understood, however, that the action taken at step 208 is not necessarily always the same as the action identified at step 200. For instance, in an open system where two users are allowed to communicate by default, then the rules defined by the system may establish policies that determined when two nodes are prevented from communicating. Should an intersection exist between the two policy sets of the nodes associated with the two users, this indicates that the nodes are to be prevented from communicating. Thus, because there is an intersection, process flow proceeds to step 208 where the system prevents the action identified at step 200 from taking place.

If there is no intersection between the policy sets of the two nodes as determined at step 206, process flow proceeds to step 210, where the system takes an appropriate action. In the example provided above where one node is allowed to perform an action with respect to another if an intersection exists, the system prevents at step 210 the action identified at step 200. If the reverse is true, however, where an intersection of policies indicates that nodes are not allowed to interact, the system allows the action identified at step 200 to occur.

Those of ordinary skill in the art should appreciate that all nodes are allowed to communicate with each other due to the assignment of Policy 1 to each node. In other words, there will be scenarios where the assignment of one policy overpowers the assignment of other policies. There will also be scenarios where an overpowering policy, such as allowing one node to act upon all the other nodes, allows nodes to interact in contradiction to other policies and rules. Another example involves assigning a policy to all nodes in a certain district or school in order to identify that each node is associated with that district or school. Because that node's policy set will intersect with the policy set of another node that is also associated with that district or school, the action will always be allowed, even if there are other rules to the contrary. In order to handle such a scenario, a level of exceptions may be applied to the nodes, as explained in more detail below.

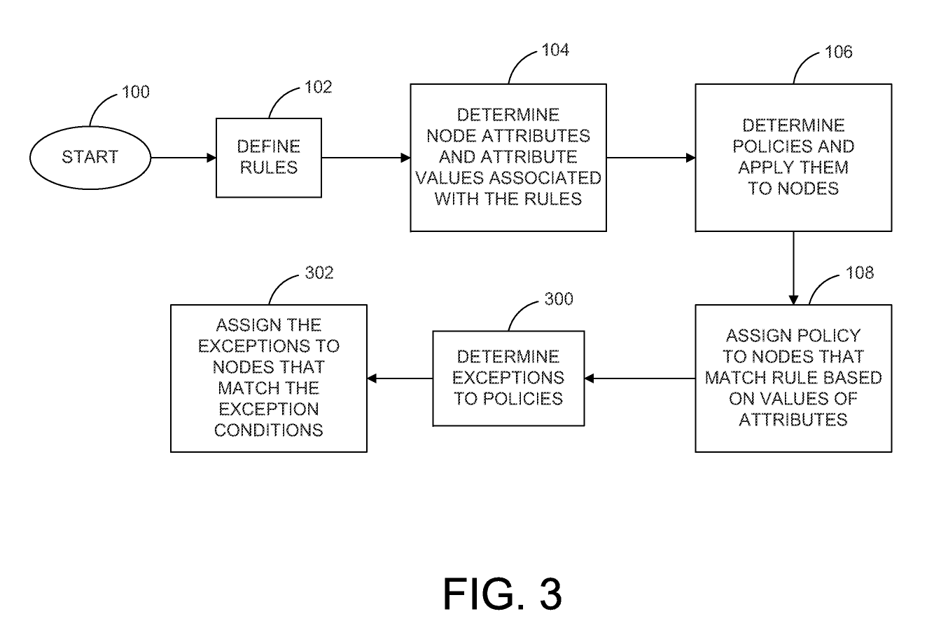

Referring to FIG. 3, for example, process flow proceeds to step 108 in a manner similar to that described above with respect to FIG. 1. Process flow then proceeds to step 300, where any exceptions to the policies are defined for the system. Each node in the system is assigned to Policy 1 because of the rule defined by the system that the superintendent is allowed to take action with respect to any other node in the system. However, students should not be able to take action with respect to one another unless allowed to by another rule or policy. Likewise, students, parents, and teachers are not allowed to communicate among one another without being connected to each other based on the association of the teacher and parent with the student or another applicable policy. For instance, users of the system should be prevented from using the devices of the system unless otherwise allowed by an explicit policy. Accordingly, in this example, the exceptions are based only on the roles attribute and may be simplified and defined as follows:
Exception 1: Teachers, students, parents, and devices are not allowed to take an action with regard to another node unless otherwise permitted by an explicit policy.

While there is only one exception in this example, it should be understood that the system may define and utilize multiple exceptions. The exceptions can then be stored in a table that associates each exception with the nodes, such as Table 12 as follows:

TABLE 12

| Node id | Exception id |
|---|---|
| 3 | 1 |
| 4 | 1 |
| 5 | 1 |
| 6 | 1 |
| 7 | 1 |
| 8 | 1 |
| 9 | 1 |
| 10 | 1 |

It should be understood that the exceptions, similar to the policies described above, may be arranged into sets and variables associated with each user node, such as a delimited array.

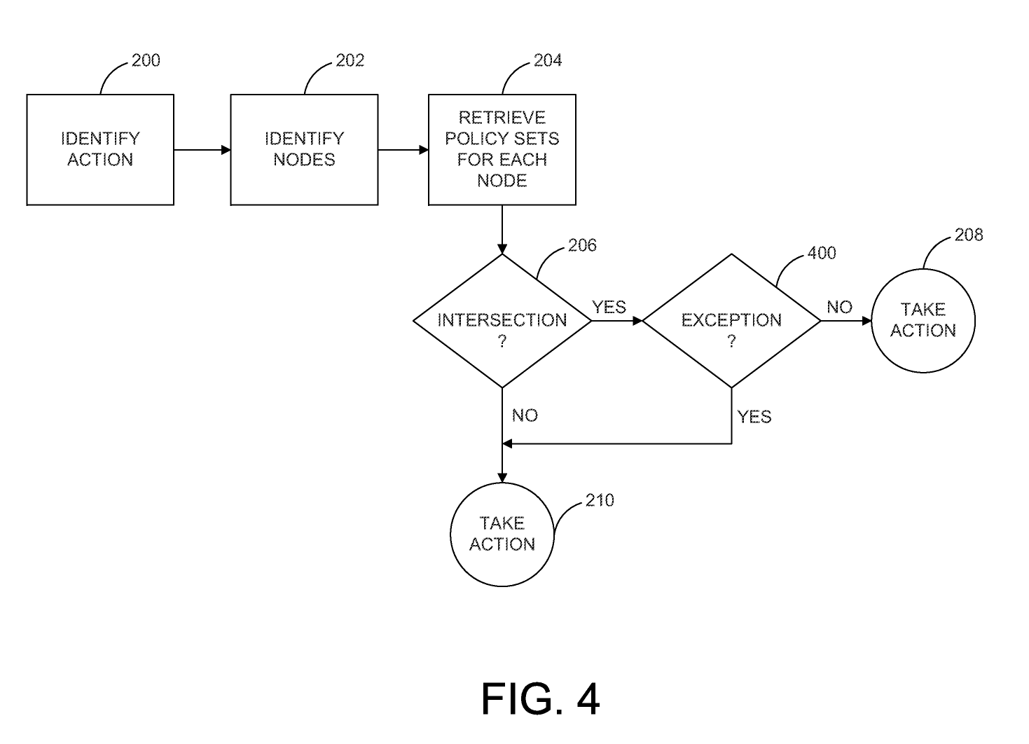

FIG. 4 is an exemplary flowchart of a process for enforcing compliance with policies assigned to nodes in a system that takes into account exceptions to the policies, as explained above. Referring to FIG. 4, process flow proceeds to step 206 in a manner similar to that described above with respect to FIG. 2. At step 206, it is determined whether an intersection exists between the policy sets of the relevant nodes. If an intersection does not exist, process flow proceeds to step 210 and continues in the manner described above. If an intersection does exist, process flow proceeds to step 400 where the system determines whether the exception set associated with one node intersects with the exception set of another node. If an intersection of the exception sets exists, process flow proceeds to step 210 and continues in the manner described above. If an intersection of the exception sets does not exist, process flow proceeds to step 208 and continues in the manner described above.

When node 3 attempts to send an email to nodes 7, 9, and 10 in this embodiment, the policy set associated with node 3 is compared to each of the policy sets associated with nodes 7, 9, and 10. Because node 3 and each of nodes 7, 9, and 10 share a common policy (Policy 1), the system compares the exception set associated with node 3 to each of the exception sets associated with each of nodes 7, 9, and 10. Because node 3 and each of these nodes share a common exception (Exception 1), the system prevents the email from being transmitted from node 3 to node 7, 9, or 10.

Those of ordinary skill in the art should appreciate that the above example allows the superintendent and principal to interact with all other nodes because the nodes associated with the superintendent and principal are not associated with an exception policy. However, the exception prevents the other nodes from interacting even though the system intends for certain nodes to be able to interact with other nodes. In the above example, for instance, node 3 should be able to communicate with at least nodes 9 and 10. In order to handle such a scenario, the system may assign a priority to each policy to determine whether the policy set is checked before or after the exception set.

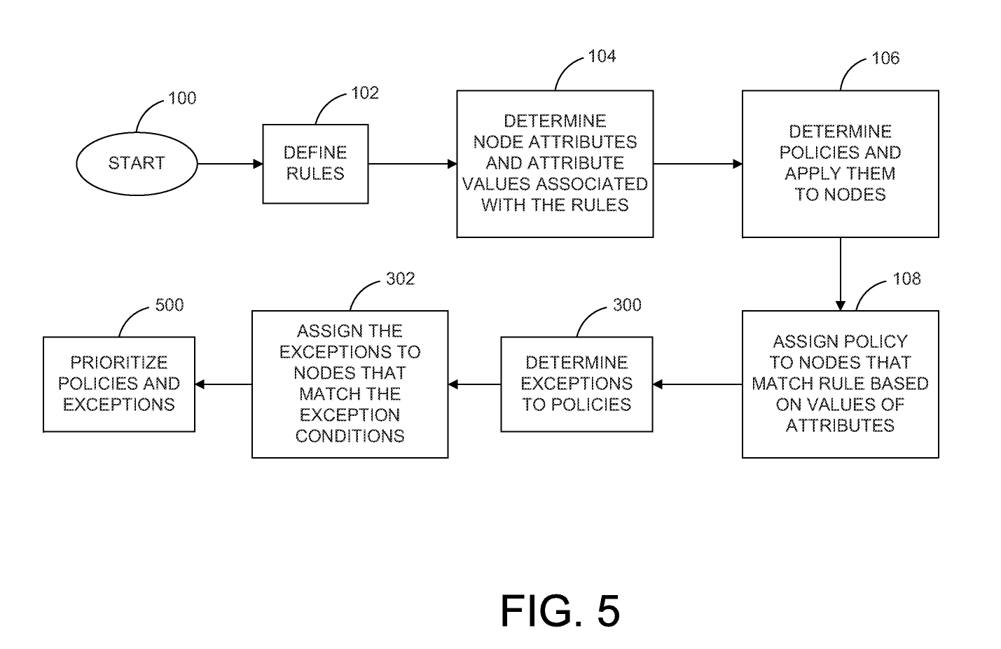

Referring to FIG. 5, for example, process flow proceeds to step 302 in a manner similar to that described above with respect to FIG. 1. At step 500, a priority is assigned to each policy, which may be done by revising Table 10 described above as follows:

TABLE 10

| Policy id | Policy | Policy Priority |
|---|---|---|
| 1 | Policy 1 | 1 |
| 2 | Policy 2 | 2 |
| 3 | Policy 3 | 2 |
| 4 | Policy 4 | 2 |
| 5 | Policy 5 | 2 |

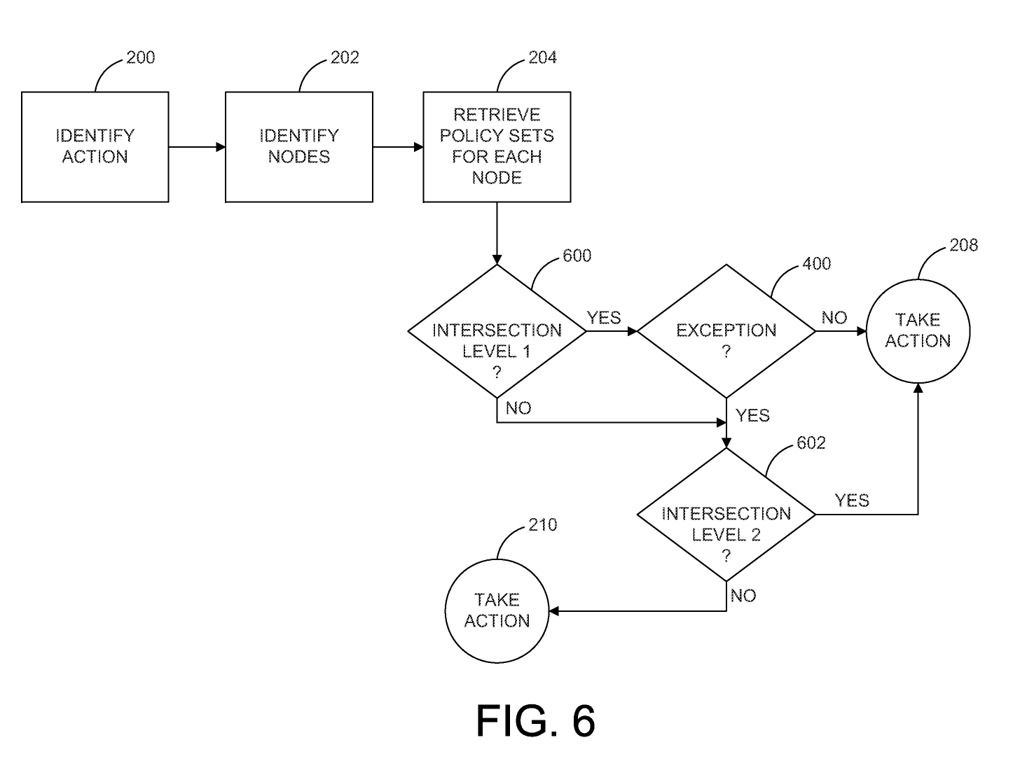

FIG. 6 illustrates an exemplary process for enforcing compliance with policies assigned to nodes in a system that accounts for priorities assigned to the policies. Referring to FIG. 6, process flow proceeds to step 204 in a manner similar to that described above with respect to FIG. 4. It should be understood that the policy sets retrieved at step 204 for the two nodes identified at step 202 may be separated according to priority. That is, the system retrieves a policy set comprising policies assigned to a node having one priority, as well as another policy set comprising policies assigned to the node having another priority.

Process flow then proceeds to step 600, where the system determines whether there is an intersection of the policy sets containing the policies having a priority value of 1 associated with the two nodes. If so, process flow proceeds to step 400, which determines whether the exception sets associated with the two nodes intersect in a manner similar to that described above with respect to FIG. 4. If there is not an intersection of the exception policy sets associated with the two nodes, process flow proceeds to step 208 and continues in a manner similar to that described above.

If there is an intersection of the exception policy sets at step 400, process flow proceeds to step 602. In the example involving the email from node 3 to nodes 7, 9, and 10, the exception set associated with node 3 shares a common exception with each of the exception sets associated with nodes 7, 9, and 10. Accordingly, flow proceeds to step 602 where the system determines if there is an intersection of the policy sets comprising policies having a priority value of “2” that are associated with the two relevant nodes. If so, this indicates that the policy sets associated with the two nodes share a policy in common that has a priority value of “2.” That is, even though the nodes share a common exception indicating the system should prevent the nodes from interacting, the nodes share a common policy that indicates the system should allow the nodes to interact. A common policy having a priority of “2” thus trumps an exception policy in this scenario. As such, the policy set of level 2 priority policies associated with node 3 shares a common policy with the policy sets of level 2 priority policies associated with nodes 9 and 10.

If the system identifies an intersection at step 602, process flow proceeds to step 208 and continues as described above. Thus, the email from node 3 is delivered to nodes 9 and 10. If an intersection does not exist between the two policy sets comprising policies having a priority of “2,” process flow proceeds to step 210 and continues as described above. Thus, in this example, the system prevents delivery of the email from node 3 to node 7 because the level 2 policy set associated with node 3 does not share a common policy with the level 2 policy set associated with node 7.

If the system does not identify an intersection at step 600, then process flow proceeds to step 602 and continues as described above. That is, if the system does not identify a common policy having a priority value of “1” between the two nodes, the system does not determine whether the nodes share a common exception, in such an embodiment. Process flow proceeds to step 602 in order to determine whether the nodes share a common policy having a priority value of “2.” While the above description presents a system and method for assigning and enforcing access policies that may be associated with two priority levels and exceptions of one level, it should be understood that the description contemplates a system having as many policies, exceptions, exception priority levels, and policy priority levels as desired. That is, steps 204, 600, 400, 602, 208, and 210 may call for an iterative process depending on the number of priority levels of both the policies and the exceptions of a system.

In another embodiment, rather than applying Policy 1 to all nodes and then requiring an exception, the system may associated a separate policy based on Rule 1 only with nodes having a value of 1 (superintendent) or 2 (principal) for the “role” attribute. In this example, the separate policy would be associated only with nodes 1 and 2, rather than all the nodes. In this instance, Policy 1 would not be applied to nodes 3, 7, 9, and 10, as well as the other nodes. As a result, node 3 would only have a policy in common with nodes 9 (Policy 5) and 10 (Policy 2) rather than all three nodes. Thus, the action between nodes 3 and 7 would be prevented without the necessity to review any exceptions to the comparison of policies.

In the presently-described embodiment, exceptions may be created to allow actions otherwise prevented, rather than prevent actions otherwise allowed. For instance, Exception 1 could be created based on the new, separate policy applied to nodes 1 and 2 described above and then applied only to the nodes associated with the separate policy; nodes 1 and 2 in this case. In this scenario, if any node attempts to act upon either node 1 or 2, such as by sending an email, the system prevents the action if the acting node is not associated with any policy with which node 1 or 2 is associated. The system then determines whether any of the nodes associated with the action are associated with an exception—Exception 1 in this example. Because nodes 1 and 2 are, the system allows the action. Those skilled in the art should appreciate that, in this scenario, the system functions the same whether a separate policy and exception are applied to nodes 1 and 2 or whether just an exception is applied to the nodes.

It should also be understood that the policy ids described above may be any alphanumeric combination of characters. Those of ordinary skill in the art should appreciate, however, that by making the ids numeric values, the system can search and compare policies associated with one node to those associated with another node faster and more efficiently. It should also be appreciated that the numeric values may be sorted in ascending or descending order to also allow for faster and more efficient comparisons. In the presently-described embodiment, the policy ids in a set associated with a node are stored in ascending order to simplify the comparison process described below.

In comparing a policy set associated with one node to the policy set associated with another node, for example, the id of the first policy in the set associated with one of the nodes is selected. It is then compared to the id of the first policy in the set associated with the other node. If the ids match, then there is an intersection between the set and the process terminates. If the first id associated with the first node is less than the first id associated with the second, then the process next selects the second id associated with the first node and starts over by comparing the second id associated with the first node with the first id associated with the second node. If the id associated with the first node being compared to those associated with the second node is greater than the id associated with the second node to which it is being compared, the process then compares the id to the next id in the set associated with the second node. Process continues in this manner until a match is found for the id, the id is smaller than the id to which it is compared, or has been compared to all the ids in the second set. The process selects the next id in the first set and repeats until there is a match or all the policies have been compared as described above.

It should be understood that the policy sets associated with the nodes may be expressed as variables other than arrays or may be represented in other arrangements as contemplated above. For instance, rather than arranging the policy ids associated with a node in a semi-colon delimited array, the policy ids may be stored in an access control list (“ACL”) or in a database or may be stored via a lightweight directory access protocol (“LDAP”). In another embodiment, for example, the numeric values may be concatenated with a symbol separating the values. Thus, the policy set for node 3 in the examples provided above may be represented as: 1.2.4.5. It should be understood that various arrangements, such as this, do not alter the assignment and enforcement of the policies in such a way as to depart from the scope of the present invention, but merely change the particular implementation.

In one embodiment, the policy sets associated with each node are stored by the system that performs the comparison so that the sets associated with nodes involved in an action may be compared when a request for the action is received. That is, when the system receives a request to perform an action or receives the action, it identifies the two nodes and retrieves the policy sets associated with each node. The process then continues as described above. In another embodiment, data representative of a policy set associated with a node is transmitted with the request to perform the action or with the action from the node. For instance, when node 3 transmits an email to nodes 7, 9, and 10, the email or data associated with the email includes data representative of the policy set. That is, “1.2.4.5” may be stored in the metadata of the email or transmitted therewith. The system tasked with delivering the email to one of the nodes, such as node 7, retrieves data representative of the policy set associated with the node and compares it to the data representative of the policy set associated with the first node that is attached to or transmitted with the action (or email in this case). The system retrieves the policy set associated with node 7, which is 1.3 in this case, and compares it to the 1.2.4.5 numerical representation of the policy set associated with node 3 in a manner similar to that described above. After the level 1 policies and the exceptions have been considered, the system tasked with delivering the email to node 7 denies, prohibits, or rejects the email because there is no intersection between 2.4.5 and 3. In contrast, the device tasked with delivering email to node 9, however, allows the email to be delivered because there is an intersection between 2.4.5 and 5.

Because the policy sets may be represented as concatenated numeric values, those of ordinary skill in the art should appreciate that hardware devices located on a network may be configured to perform the comparisons described above in order to determine whether actions should be allowed between nodes on the network. For example, a router may be configured to retrieve data representative of a policy set associated with a node on its network at which an action received by the router has been directed. The router may be configured to then compare the data it retrieved with the data representative of the policy set associated with the node requesting or sending the action. The router may then permit or deny the action based on the comparison in a manner similar to that described above.

It should be understood that one requirement for such an embodiment to function is that the policy ids contained in the policy sets identify the same policy across the nodes and system. That is, a policy or exception id of 5 associated with one node must refer to the same policy or exception if it is associated with another node. If they are different, the system may allow two nodes to interact based on a misunderstanding of the underlying policies or exceptions.

The above methodology may also be applied to systems comprising groups both organized in hierarchies and those that are not. In another embodiment, however, the methodology may be applied to systems that are not organized in hierarchies or that are not organized in groups. In such an embodiment, a database schema is configured to assign policies to users, similar to the description set forth above. In this example, policies are assigned to nodes based on attributes and characteristics of each node, as explained above. In the case of users, these attributes or characteristics may be the user's role and the source of the user's action. In an educational system, for instance, a student within the New York City school system may be assigned certain policies, while a teacher located within the District of Columbia may be assigned certain other policies.

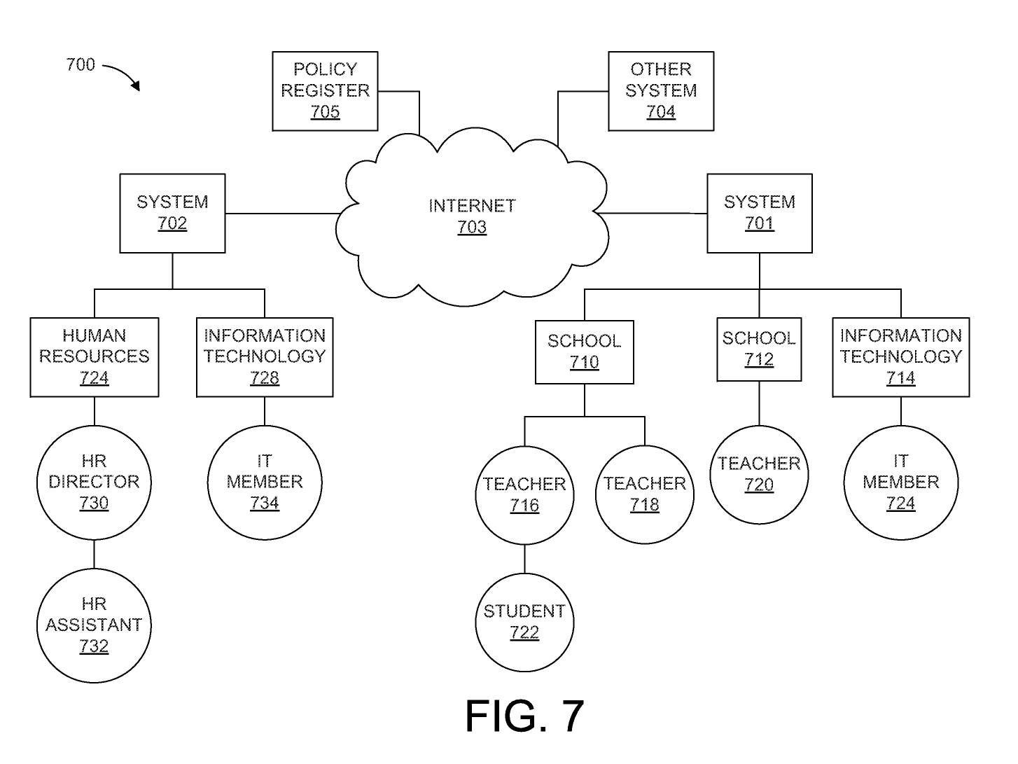

FIG. 7 illustrates a system 700 for assigning and enforcing policies assigned to nodes that are distributed across multiple subsystems. For instance, system 700 comprises subsystems 701 and 702 operatively connected via a wide area network (or “WAN”), such as the Internet 703. Other systems, such as system 704 may also be operatively connected to systems 701 and 702 via Internet 703. Additionally, a policy register 705 is operatively connected to Internet 703.

System 701 comprises schools 710 and 712 and an Information Technology (“IT”) Department 714. School 710 includes teachers 716 and 718, while school 712 comprises a teacher 720. Teacher 716 has at least one student 722. IT 714 includes at least one IT member 724.

System 702 comprises a Human Resources (“HR”) Department 726 and an IT Department 728. HR 726 includes an HR director 730 who has at least one HR assistant 732, while IT 728 includes at least one IT member 734.

As explained above, each item in a network may be referred to as a node. For instance, the users of system 700 are nodes of the network, as well as the devices that define the physical network. This includes teachers 716, 718, and 720, IT members 714 and 734, student 722, HR Director 730, and HR assistant 732. This also includes the router, server, firewall, network address translation device, or other machine that provides members of system 701 with access to Internet 703.

The nodes, attributes of the nodes, values of the attributes, rules, policies, exceptions, and policy sets may be defined for system 700 in a manner similar to that described above. The policies and exceptions may then be assigned to each node in system 700 in a manner similar to that described above. Thus, IT members 724 and 734 may be assigned with policies that allow all members of an IT department to communicate with one another and also allows an IT member to interact with any other node inside of the same subsystem. For example, IT member 724 may be assigned a policy that allows the member to interact with other nodes corresponding to users, such as by emailing those users, and with the device that corresponds to system 701's connection to Internet 703, such as to reconfigure the device inside of system 701. In this embodiment, the set of policies and exceptions may be represented as a string of number values connected by periods, as described above, similar to the form of an address compliant with version four of the internet protocol (“IPv4”). As explained above, this number may be embedded within or attached to transmissions, requests, and actions made by a node. Each device through which the requested action passes may be configured to determine, based on the policy set associated with the device and the policy set attached to the action, whether the requesting node is allowed to interact with that device, in a manner similar to the explanation above, and, if so, pass the requested action on to the next device or the destination. The device tasked with delivery or performing the requested action with regard to the node to which the action is directed determines whether the requesting node is able to interact with the receiving node based on a comparison of the two nodes' policy sets, as explained above.

In the presently-described embodiment, the policies upon which the above determinations are made are stored within each of the relevant systems. For example, the policies that determine whether nodes within system 701 are allowed to interact are stored within the system so that the system can perform the policy set comparison described above. Likewise, system 702 maintains the storage of policies that determine whether nodes within its system have the ability to perform actions with respect to one another. If systems 701 and 702 are to be configured to determine whether actions from a node in one system is allowed to be performed with respect to a node in the other system, both systems should be able to access a commonly defined policy list. In the presently-described embodiment, policies that systems 701 and 702 seek to enforce across both systems are stored in policy register 705.

By way of a simplified example, for instance, systems 701 and 702 agree that nodes associated with a first policy stored in policy register 705 (referred to as “P1”) are allowed to communicate. The first policy is based on a rule that allows members of any IT department to communicate. Accordingly, P1 is associated with IT members 724 and 734 and stored in their respective policy sets. Should IT member 724 send an email to IT member 734, assuming there are no other relevant policies or exceptions, both systems would allow the email to be sent and received. However, if P1 is the only defined policy between the two systems and teacher 716 sends an email to HR Director 730, or vice versa, both systems will prevent the email from being delivered.

It should be understood that each system may continue to maintain an internal list of policies that govern interaction of the nodes inside of the respective system. It should be appreciated, however, that should the systems wish to enforce a policy across both systems, it should be defined in policy register 705 (or another commonly-accessible registry) so that it conveys the same policy to both systems. It should also be understood that systems 701 and 702 prevent the nodes within other system 704 from communicating with those inside systems 701 and 702 until a common policy is assigned to one or more of the nodes of system 704 and stored in policy register 705.

It should further be understood that any encoding process may be used to identify the policy sets associated with a node as long as the receiving system is capable of decoding the policy set. For instance, it should be understood that any number of digits and configuration of numeric and alphanumeric characters may be used to identify the sender and/or receiver of a transmission or action for access control purposes, as well as the policies associated with the relevant nodes. For instance, each transmission may be associated with a numeric value complying with IP, version six, or “IPv6.” That is, system 700 may associate 128-bit addresses to each node in order to identify the sender and intended recipient of a transmission, as well as the policy sets associated with each. This value may be used to determine whether the nodes are allowed to interact.

In one embodiment, for instance, a portion of the alphanumeric value may identify the recipient, while another portion identifies the policies associated with the sender. A receiving device need only identify and compare the policy set of the recipient with that identified by the alphanumeric value to determine whether the device should prevent the requested action. It should therefore by understood that any portion of the alphanumeric or numeric value may be used to identify the sender, recipient, policy set of the sender, and/or policy set of the recipient, or any combination thereof as desired in order to increase the efficiencies of transmissions based on the capabilities of the device(s) tasked with handling the requested actions or transmission of the requested actions without departing from the scope of the present invention. For instance, a portion of the alphanumeric value may be used to locate and route the transmission or requested action to the intended recipient, while another portion of the value may be used to determine whether the transmission or action should be allowed.

While one or more preferred embodiments of the invention have been described above, it should be understood that any and all equivalent realizations of the present invention are included within the scope and spirit thereof. The embodiments depicted are presented by way of example only and are not intended as limitations upon the present invention. Thus, it should be understood by those of ordinary skill in this art that the present invention is not limited to these embodiments since modifications can be made. Therefore, it is contemplated that any and all such embodiments are included in the present invention as may fall within the scope and spirit thereof.

What is claimed is:

1. A method for managing an action from one node to another node on a computer network, the method comprising the steps of:
defining a rule for the action based on at least one value derived from one or more attributes of the nodes;
defining at least one policy based on the rule to facilitate implementation of the rule;
associating the one node with a first policy set wherein the first policy set is configured to include policies;
associating the another node with a second policy set wherein the second policy is configured to include policies;
assigning the at least one policy to the first policy set based on the at least one derived value of the one or more attributes of the one node;
assigning the at least one policy to the second policy set based on the at least one derived value of the one or more attributes of the another node;
comparing the first policy set with the second policy set to find an intersection between the first and second policy sets; and
managing the action based on the intersection.

2. The method of claim 1 wherein the step of managing the action based on the intersection comprises denying the action.

3. The method of claim 1 wherein the step of managing the action based on the intersection comprising allowing the action.

4. The method of claim 1 further comprising managing the action based on a rule associated with the action.

5. The method of claim 1 further comprising defining a plurality of policies based on the rule to facilitate implementation of the rule.

6. The method of claim 5 further comprising organizing the plurality of policies into a multi-level hierarchy.

7. The method of claim 6 further comprising assigning a priority to each level of the multi-level hierarchy and managing the action based on the priority of each level.

8. The method of claim 5 further comprising managing the action based on a priority associated with the intersection.

9. The method of claim 1 wherein the action is selected from the group comprising communicating, accessing a resource, executing a program, reading a file.

10. The method of claim 1 further comprising managing a second action from the one node to the another node based on the intersection.

11. A method for managing an action between a first node and a second node on a computer network, wherein a rule for the action is based on a first derived value from a first attribute of the nodes, a first policy is based on the rule to facilitate implementation of the rule, the first node is associated with a first policy set, the second node is associated with a second policy set, the first policy is assigned to the first policy set based on the first derived value of the first attribute of the node, and the first policy is assigned to the second policy set based on the first derived value of the first attribute of the another node, the method comprising the steps of:
receiving a request for the action from one of the nodes; and
managing the action based on whether there is an intersection between the first and second policy sets.

12. The method of claim 11 further comprising allowing the action if the intersection exists.

13. The method of claim 11 further comprising denying the action if the intersection exits.

14. The method of claim 11 further comprising managing the action based on a priority associated with the first policy.

15. The method of claim 11 wherein the action is a transmission of an electronic message.

16. The method of claim 11 wherein the action is a posting on a web log.

17. A system for managing an action between nodes on a computer network comprising:
a processing device; and
memory operatively connected to the processing device, wherein the memory comprises instructions that, when executed by the processing device, cause the processing device to:
identify a first node and a second node from the action;
retrieve a first set associated with the first node, wherein the first set represents policy groups to which the one node is associated, wherein the policy groups are defined based on a rule for the action, wherein the rule is based on derived values of attributes associated with the nodes;
retrieve a second set associated with the second node, wherein the second set represents policy groups to which the another node is associated; and
manage the action based on whether there is an intersection between the first and second sets.

18. The system of claim 17 wherein each policy group is expressed as a numeric value.
